(19) United States
(12) Patent Application Publication
(10) Pub. No.: US 2010/0294060 A1
(43) Pub. Date: Nov. 25, 2010

(54) DUAL CLUTCH TRANSMISSION

(75) Inventors: Gerhard Gumpoltsberger, Friedrichshafen (DE); Juergen Wafzig, Eriskirch (DE); Matthias Reisch, Ravensburg (DE); Wolfgang Rieger, Friedrichshafen (DE); Ralf Dreibholz, Meckenbeuren (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/681,923

(22) PCT Filed: Oct. 8, 2008
(86) PCT No.: PCT/EP2008/063418

§ 371 Date: Apr. 7, 2010

(30) Foreign Application Priority Data
Oct. 15, 2007 (DE) 102007049257.1

(51) Int. Cl. F16H 3/08

(52) U.S. Cl. 74/331

(57) ABSTRACT

A double clutch transmission with two clutches connected to a drive shaft and to one of two transmission input shafts. Fixed gears are coupled to the input shafts and engage idler gears. Several coupling devices connect the idler gears to a countershaft which have an output gear that couples to an output shaft such that forward and reverse gears can be shifted. Two dual gear planes each comprising two idler gears, each supported by a respective countershaft, and one fixed gear. In each dual gear plane, at least one idler gear wheel can be used for at least two gears. Two single gear planes each comprise an idler and a fixed gear such that a winding-path gear is shifted by disengaging an output gear wheel coupling device on the first countershaft. Another winding-path gear is shifted by disengaging an output gear wheel coupling device on the second countershaft.

This application is a National Stage completion of PCT/EP2008/063418 filed Oct. 8, 2008, which claims priority from German patent application serial no. 10 2007 049 257.1 filed Oct. 15, 2007.

### FIELD OF THE INVENTION

The present invention relates to a dual clutch transmission for a motor vehicle.

### BACKGROUND OF THE INVENTION

Known from the publication DE 103 05 241 A1 is a 6-speed or 7-speed dual clutch transmission. The dual clutch transmission comprises two clutches, each connected with their inputs to the drive shaft and their output to one of the two transmission input shafts. The two transmission input shafts are coaxially positioned toward each other. In addition, two countershafts are positioned axially parallel to the transmission input shafts, their idler gear wheels mesh with the fixed gear wheels of the transmission input shafts. Furthermore, coupling devices are connected in a axial movable rotationally fixed manner to the countershaft to shift the respective gear wheels. Each selected ratio is transferred by the drive gear wheels to a differential transmission. To achieve the desired gear ratio steps in this known dual clutch transmission, a large number of gear wheel planes are required, so that a significant installation space is needed.

In addition, a spur gear change speed transmission is known from the publication DE 38 22 330 A1. The spur gear change speed transmission comprises a dual clutch, switchable under power, where one part is connected with a drive shaft and another part with a hollow drive shaft, that is rotatably arranged on the drive shaft. For certain gear ratios, the drive shaft can be coupled to the hollow drive shaft via a shifting device.

Known from the publication DE 10 2004 001 961 A1 is a power shift transmission with two clutches, which each are assigned to a partial transmission. The transmission input shafts of the two partial transmissions are positioned coaxial to each other and mesh, via fixed gear wheels, with idler gear wheels of the designated countershaft. The respective idler gear wheels of the countershafts can be connected, in a rotationally fixed manner, with the respective countershaft through designated shifting devices. The particular idle wheels of the countershaft can be connected in a rotationally fixed manner through the assigned shifting devices with the associated countershaft. A 7-gear transmission, among other things, is known from this publication in which an additional shift element is provided to connect the two transmissions input shafts to establish an additional transmission stage. The 7-gear transmission requires in this embodiment at least six gear wheel planes in the two partial transmissions, to achieve the transmission stages. This increases the axial length of needed installation space, it therefore significantly limits the use in a motor vehicle.

### SUMMARY OF THE INVENTION

It is the task of the present invention to propose a dual clutch transmission based on the previously described type, in which power engaging gear ratio steps can be realized, possibly cost-efficient and with just a few component parts, which need little installation space.

Thus, a dual clutch transmission with two clutches, optimized for needed installation space, is proposed, in which the inputs are connected with a drive shaft and the outputs are each connected with one of two coaxial transmission input shafts. The dual clutch transmission comprises at least two countershafts, on which gear wheels, designed as idler gearwheels, are rotatably positioned, and positioned in a rotationally fixed manner on the two transmission input shafts are gear wheels, designed as fixed wheels, which at least partially mesh with the idler gear wheels. In addition, several coupling devices are provided for connecting an idler gear wheel with a countershaft in a rotationally fixed manner. The dual clutch transmission, in accordance with the invention, has one output gear wheel each, or constant pinion, respectively, at the two countershafts, which each are coupled with gears of a drive shaft, to connect the respective countershaft with the output, and to have at least an activated or engaging shifting device as a so called winding-path gear shifting device for connecting two gear wheels in a rotationally fixed manner, whereby several power shiftable forward gears and at least one reverse gear can be shifted.

The inventive dual clutch transmission can preferably comprise just four gear planes, whereby at least one of the two output gear wheels is shiftably connected with the respective countershaft. For instance, two dual gear planes are provided in the dual clutch transmission and in each dual gear plane, one idler gear wheel on the first and on the second countershaft is assigned to a fixed gear wheel of one of the transmission input shafts, whereby in each dual gear plane at least one idler gear wheel can be used for at least two gears, and whereby, for instance, two single gear planes are provided, where one idler gear wheel on the countershafts is assigned to a fixed gear wheel on one of the transmission input shafts, so that at least one winding-path gear can be shifted via at least one shifting device on the first countershaft and at least one winding path-gear can be shifted, with at least one disengaged coupling device on the second countershaft, assigned to the output gear wheel. In the disengaged condition of the coupling device, the respective output gear wheel can be decoupled from the assigned countershaft, whereby, in the disengaged or non-activated state, respectively, the coupling device which is assigned to the output gear wheel is engaged, so that the respective output gear wheel is connected with the assigned countershaft in a rotationally fixed manner. Due to the possible multi-use of idler gear wheels, the proposed dual clutch transmission enables a maximum number of gear ratios with as few gear planes as possible, preferably all forward gears and all reverse gears are power shiftable in sequential execution.

Through the use of two single gear planes, instead of one dual gear plane, one fixed gear wheel is replaced by two fixed gear wheels, harmonized, progressive gear stepping can be achieved in this inventive dual clutch transmission, especially for the fourth, fifth, sixth, and seventh gears. In addition, a maximum of four shifting devices are used for each countershaft, which are realized by shifting devices and/or coupling devices, thus resulting in a maximum of two activating devices on each countershaft. Furthermore, the last or the second to last gear step in this inventive dual clutch transmission can be designed higher than the respective current gear, to provide the driver with a lot of torque and drive power when shifting. Also, the highest power shiftable gear can be designed as a winding-path gear.

The inventive and proposed dual clutch transmission can preferably be designed as a 7-gear transmission. Due to the reduced amount of required installation space, as compared to known transmission configurations, the inventive dual clutch transmission is especially applicable in a front-transverse constructions. However, other constructions are also possible, and depend on the design and the available amount of installation space in the respective motor vehicle.

It can be provided, within the scope of a possible embodiment of this invention, that, via the shifting device on the first countershaft, an idler gear wheel of the second partial transmission can be connected with an idler gear wheel of the first partial transmission, so that via the activated or engaged shifting device, at least one forward gear and/or a reverse gear can be shifted as a winding-path gear, and that disengagement of the coupling device on the second countershaft the output gear wheel is decoupled from the second countershaft, so that at least a seventh forward gear can be shifted. Hereby, the first forward gear, as well as the seventh forward gear, can be realized via the gear wheel steps of the second and fourth forward gears, whereby only three shifting coupling devices, respectively, are required on the countershafts. It is possible, based on the previously named embodiment, to shift by way of disengagement of a non-engaged coupling device, a low speed gear as a winding-path gear.

In accordance with another embodiment of this invention, it can be provided that the first forward gear can also be shifted as a winding-path gear when the coupling device is disengaged. Also, other applications are possible to realize additional winding-path gears.

Through the inventive dual clutch transmission, winding-path gears can be realized, via at least one disengaged coupling device and via at least one engaged shifting device, in which gear wheels of both partial transmissions are coupled with each other, to achieve a flow of force through both partial transmissions. The applied coupling device, in each case, separates the respective output gear wheel from the assigned countershaft, when the used coupling device is non-engaged. Because of having at least one shiftable output gear wheel on a countershaft, not only more winding-path gears can be realized as compared to using just one shifting device, but the gear ratio steps can be adjusted. The used shifting device serves hereby for the coupling of two idler gear wheels and it brings the transmission input shafts into dependency of each other.

Independent of the respective embodiment of the dual clutch transmission, the positioning of the shifting device for the coupling of two defined idler gear wheels can be varied, so that the shifting device does not have to be necessarily positioned between the idler gear wheels which have to be coupled. Thus, also other placement of the shifting s devices are possible, to optimize, for instance, coupling to an actuating device.

It can be provided with the dual clutch transmission, in accordance with a possible embodiment, that the first gear plane, designed as dual gear plane, comprises a fixed gear wheel on the second transmission input shaft of the second partial transmission, and that the second gear plane, designed as dual gear plane, and the third and fourth gear plane, designed as single gear plane, comprises three fixed gear wheels on the first transmission input shaft of the first partial transmission. However, it is also possible, in a different embodiment, that the first gear plane, designed as dual gear plane, comprises a fixed gear wheel on the second transmission input shaft of the second partial transmission, and that the second, and the third gear plane, designed as single gear plane, and the fourth gear plane, designed as dual gear plane, comprises three fixed gear wheels on the first transmission input shaft of the first partial transmission. Hereby, independent of the respective embodiment, each of the four fixed gear wheels of the transmission input shaft can be used for at least two gears. Preferably, the maximum of four shifting points can be used on each countershaft, to get by with just maximal two actuator devices for activating the shifting locations. Also, other embodiments are possible. For instance, the configuration of different gear wheel ratio steps can provide, that the gear ratio steps for the a third, fourth and fifth power shiftable forward gears are located in one gear plane. Also, the gear wheel step of the second power shiftable forward gear, for instance, and at least of one reverse gear can be located in one gear plane. In an advantageous way, just three idler gear wheels are needed on a countershaft for the forward gearing, which mesh with the fixed gear wheels of the transmission input shaft, and just two idler gear wheels are needed on the other countershaft, which also mesh with fixed gear wheels of the transmission input shafts.

For the realization of the reverse gears in this inventive dual clutch transmission, an intermediate gear wheel can be used, which, for instance, is positioned on an intermediate shaft. It is also possible, that one of the idler gear wheels on a countershaft serves as in intermediate gear wheel for at least one reverse gear. Hereby, no additional intermediate shaft is required for the reverse gearing, as one of the idler gear wheels meshes with a fixed gear wheel as well as with an additional, shiftable idler gear wheel on the other countershaft. Hereby, the intermediate gear wheel, required for the reverse gear, is positioned as a shiftable idler gear wheel on a countershaft and serves, in addition, for the realization of at least an additional forward gear. The intermediate gear can always be designed as a step gear, independent of the positioning intermediate gear wheel on the countershaft or on the additional intermediate shaft.

To achieve the required gear ratio steps, the inventive dual clutch transmission can provide that, on each countershaft, at least one dual action coupling device is positioned as a shifting location. The provided coupling devices can each, in the activated mode and dependent on the operating direction, connect an assigned idler gear wheel to the countershaft in a rotationally fixed manner. In addition a single action shifting device can be positioned on at least one countershaft as a shifting location. As coupling devices, for instance, hydraulic, electric, pneumatic, mechanically operated clutches can be used, or also interlocking claw clutches or any kind of synchronization device can be applied, which serves for a rotationally fixed connection of an idler gear wheel with a countershaft. It is also possible, that a dual action coupling device is replaced by two single side operating coupling devices or vice versa.

It is possible that the mentioned options for positioning of the gear wheels vary, and also the number of gear wheels and the number of coupling devices are altered to realize additional power engaging and non-power engaging gears, for further reduction of required installation space and component cost reduction for this inventive dual clutch transmission. Fixed wheels of dual gear planes can be split into two fixed wheels for two single gear planes. Hereby, gear ratio shifting can be improved. It is also possible, to swap the countershafts. The partial transmissions can also be swapped, meaning mirror imaging around a vertical axle. Hereby, the hollow shaft and the solid shaft are swapped. It is possible hereby to position the smallest gear wheel on the solid shaft, to further optimize the use of the available installation space. In addition, neighboring gear wheel planes can be swapped, to optimize deflection of the shaft and/or connecting of a shifting actuator device. Also, the respective mounting position of the coupling devices on the gear wheel plane can be varied. In addition, also the actuation direction of the coupling devices can be varied.

The fear numbering used herein is freely defined. It is also possible to add a low speed gear, to improve the off road characteristics or the acceleration performance of a motor vehicle. In addition, the first gear can be left out to better optimize the entirety of the gear steps. The numbering of the gears varies through these measures accordingly.

The proposed dual clutch transmission is preferably equipped with an integrated output stage. The output stage can comprise as an output gear wheel a fixed gear wheel on the output shaft, which meshes with the first output gear wheel on the first countershaft, and a second output gear wheel on the second countershaft. Depending on the embodiment, at least one of the output gear wheels is designed to be a shiftable gear wheel via a coupling device.

Advantageously, the lower forward gears and the reverse gears can be activated through a starting, or shifting clutch to hereby focus higher loads on this clutch and to construct the second clutch with less needed installation space and as more cost-effective. Especially, the gear wheel planes in the proposed dual clutch transmission can be positioned in a way that one can start, through the inner transmission input shaft or the outer transmission input shaft, to always start through the more appropriate clutch, which is also possible in a concentrically positioned, radial nested configuration of the dual clutch. The gear wheel planes can be positioned as mirror-symmetric, or swapped. It is also possible that the countershafts are swapped or positioned as in a mirror image.

Independent of the respective, for instance, the provided gear wheel planes of the dual clutch transmission can be swapped. It is also possible, to use two single gear wheel planes instead of a dual gear wheel plane, and/or vice versa. In addition, the two partial transmissions can be positioned as mirror image.

### BRIEF DESCRIPTION OF THE DRAWINGS

Following, the present invention is further explained based on the drawings. It shows:

FIG. 1 a schematic view of a first embodiment of an inventive 7-gear dual clutch transmission;

FIG. 2 a shift scheme of the first embodiment in accordance with FIG. 1;

FIG. 3 a schematic view of a second embodiment of the inventive 7-gear dual clutch transmission;

FIG. 4 a shift scheme of the second embodiment in accordance with FIG. 3;

FIG. 5 a schematic view of a third embodiment of the inventive 7-gear dual clutch transmission;

FIG. 6 a shift scheme of the third embodiment in accordance with FIG. 5;

FIG. 7 a schematic view of the fourth embodiment of the inventive 7-gear dual clutch transmission;

FIG. 8 a shift scheme of the fourth embodiment in accordance with FIG. 7;

FIG. 9 a schematic view of the fifth embodiment of the inventive 7-gear dual clutch transmission; and

FIG. 10 a shift scheme of the fifth embodiment in accordance with FIG. 9.

### DETAILED DESCRIPTION OF THE PREFERRED EMBODIMENTS

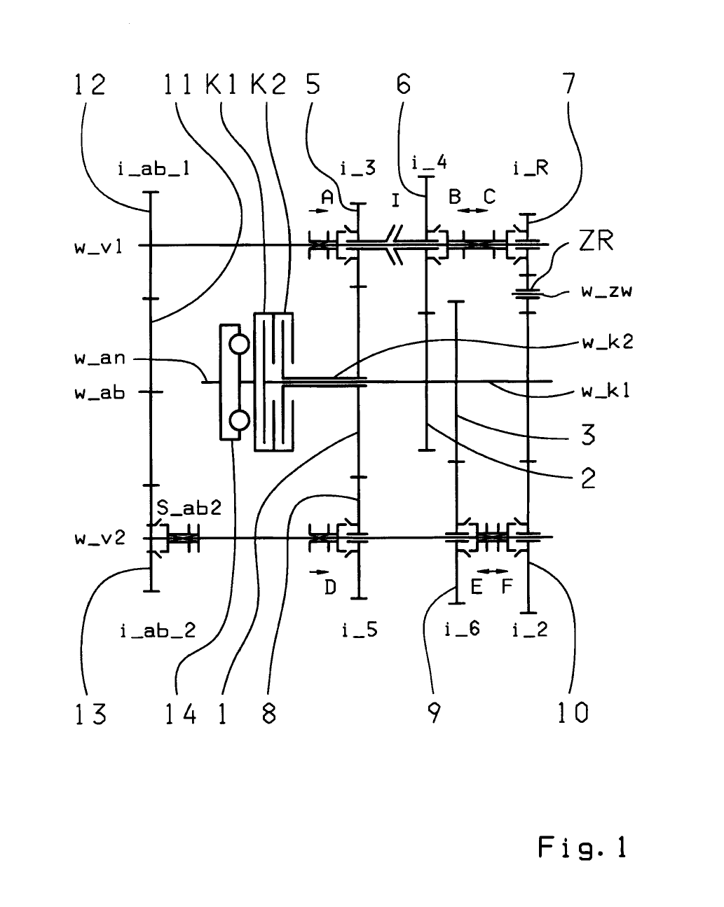

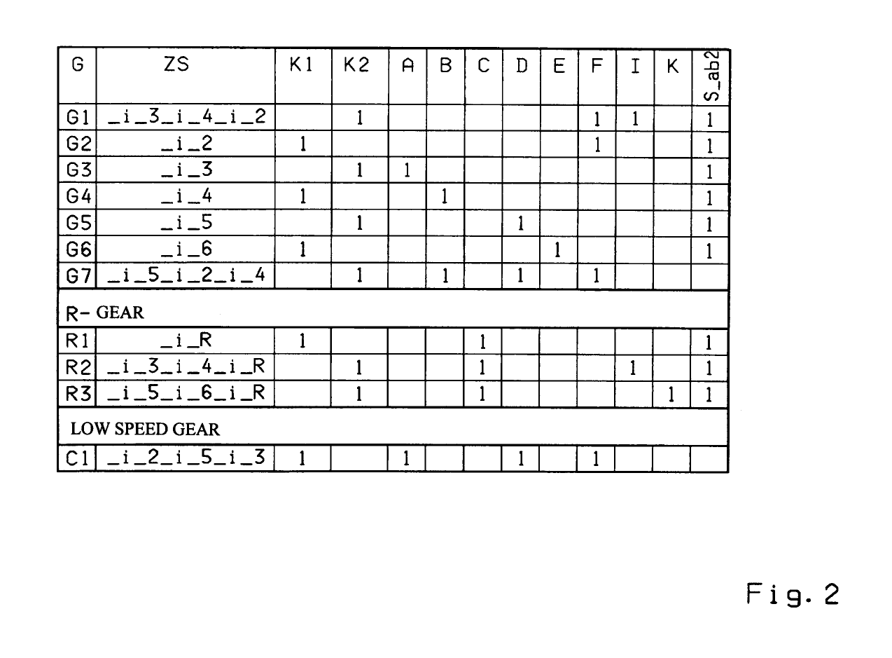

FIGS. 1, 3, 5, 7, and 9 each show a possible embodiment of a 7-gear dual clutch transmission. The respective shifting schemes, in accordance with the embodiments, are presented accordingly as tables in the FIGS. 2, 4, 6, 8, and 10.

The 7-gear dual clutch transmission comprises, independent of the respective embodiments, two clutches, K1, K2, in which the input sides are connected to a drive shaft w_an, and the output sides are each connected with one of the two, coaxial transmission input shafts w_K1, w_K2. Also, a torsional vibration damper 14 can be positioned at the drive shaft w_an. In addition, two countershafts w_v1, w_v2 are provided, on which gear wheels are rotatably positioned, designed as idler gear wheel 5, 6, 7, 8, 9, 10. On the two transmission input shafts w_K1, w_K2, gear wheels are positioned, rotatable and designed as fixed wheels 1, 2, 3, 4 which at least partially mesh with the idler gear wheels 5, 6, 7, 8, 9, 10.

To connect the idler gear wheels 5, 6, 7, 8, 9, 10 with the respective countershafts w_v1, w_v2, several, activated coupling devices A, B, C, D, E, F are provided on the countershafts w_v1, w_v2. In addition, output gear wheels 12, 13, designed as constant pinions, are positioned on the two countershafts w_v1, w_v2, and are coupled with the gearing of an output shaft w_ab, whereby at least the output gear wheel 13 is shiftable and assigned to the second countershaft w_v2.

Thus, just four gear planes are provided in this inventive dual clutch transmission, whereby in each embodiment two gear planes 5-8, 6-9; 5-8, 7-10 are provided, and whereby two single gear planes 6-2, 3-9; 7-3, 4-10 are provided, so that at least one winding-path gear can be shifted at least via one shifting device I on the first countershaft w_v1, and at least one winding-path gear can be shifted via a non-engaged coupling device S_ab2, assigned to the output gear wheel 13 on the second countershaft w_v2.

Thus, the dual clutch transmission provides, beside the coupling devices A, B, C, D, E, F, which realizes a rotationally fixed connection between a gear wheel and the assigned countershaft w_v1, w_v2, at least a coupling device S_ab2 on the second countershaft w_v2, which is assigned to the output gear wheel 13, which disengages for shifting at least one winding-path gear, to disconnect the output gear wheel 13 from the second countershaft w_v2. In addition, at least the shifting device I is provided on the first countershaft w_v1, such that at least shift a winding-path gear via the activated or engaged, respectively, shifting device I, in which the shifting device I connects in a rotationally fixed manner the idler gear wheel 5 with the idler gear wheel 6 on the second countershaft w_v1.

Independent of the respective embodiment of the dual clutch transmission, the idler gear wheel 5 of the second partial transmission is connected with the idler gear wheel 6 of the first partial transmission via the shifting device I on the first countershaft w_v1, so that, via the activated or engaged shifting device I, at least a first forward gear G1 and/or a reverse gear R1, R2 can be shifted as a winding-path gear, whereby, when the coupling device S_ab2 on the second countershaft w_v2 is not engaged, the output gear wheel 13 is decoupled from the second countershaft w_v2, so that at least a seventh forward gear G7 can be shifted.

It is possible, in the first and second embodiment, to shift, when the coupling device S_ab2 is not engaged, a low speed gear C1 also as a winding-path gear. In accordance with the fourth embodiment, when the coupling device S_ab2 is not engaged, a first forward gear G1 can be shifted as a winding-path gear.

Thus, independent from the respective embodiment of the dual clutch transmission, the first and the highest forward gear are winding-path gears.

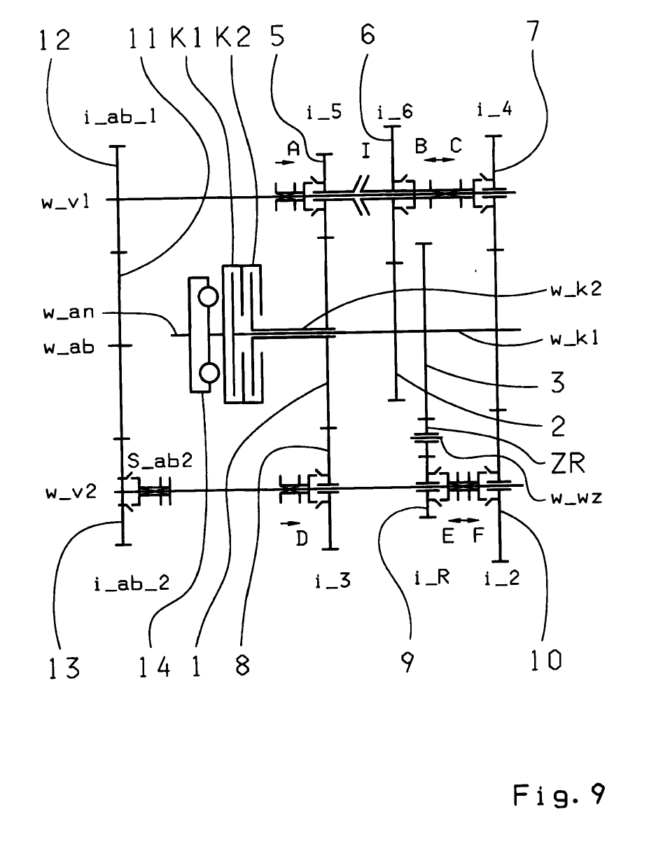

In the first embodiment, in accordance with FIG. 1, in the first gear plane, designed as dual gear plane 5-8, the fixed gear wheel 1 on the second transmission input shaft w_K2 meshes with the idler gear wheel 5 on the first countershaft w_v1 and the idler gear wheel 8 on the second countershaft w_v2. In the second gear plane, designed as single gear plane 6-2, the fixed gear wheel 2 of the first transmission input shaft w_K1 meshes only with the idler gear wheel 6 on the first countershaft w_v1. In the third gear plane, designed as single gear plane 3-9, the fixed gear wheel 3 on the first transmission input shaft w_K1 meshes with the idler gear wheel 9 on the second countershaft w_v2. Finally in the fourth gear plane designed as dual gear plane 7-10, the fixed gear wheel 4 of the first transmission input shaft w_K1 meshes with the idler gear wheel 10 on the second countershaft w_v2 and the intermediate gear ZR, whereby the intermediate gear ZR enables the reversal of rotation for the realization of the reverse gears R1, R2, R3. The intermediate gear ZR is rotatably positioned on the intermediate shaft w_zw, whereby the intermediate shaft w_zw, in this example, is positioned parallel to the countershafts w_v1, w_v2. The intermediate gear ZR also meshes with the idler gear wheel 7 on the first countershaft w_v1. The fifth embodiment, in accordance with FIG. 9, only differs by the fact, that the positioning of the intermediate gear ZR, for the reversal of rotation, is realized in the a third gear plane, designed as single gear plane 3-9, between the fixed gear wheel 3 and the idler gear wheel 9.

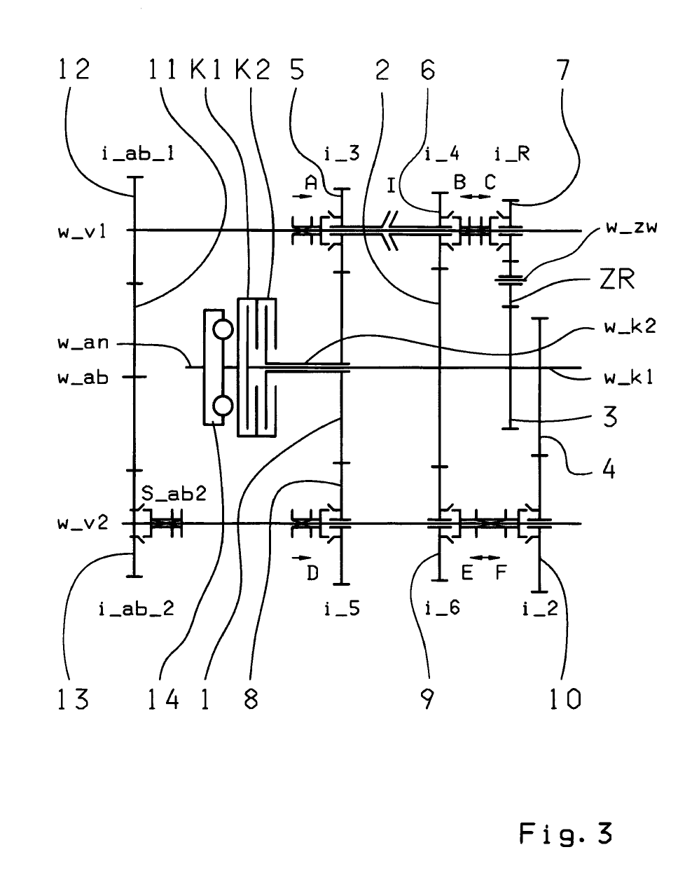

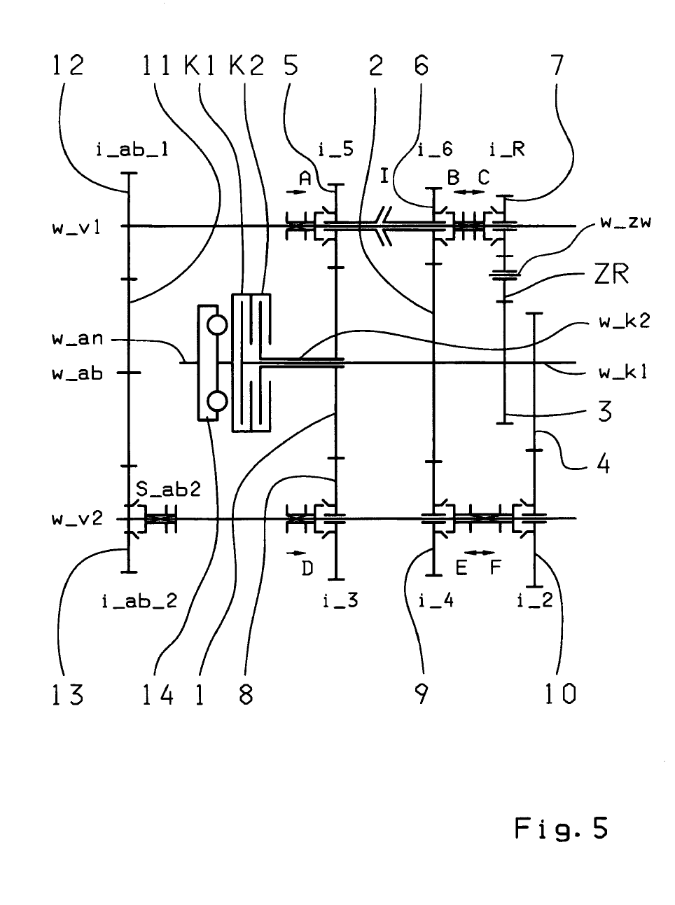

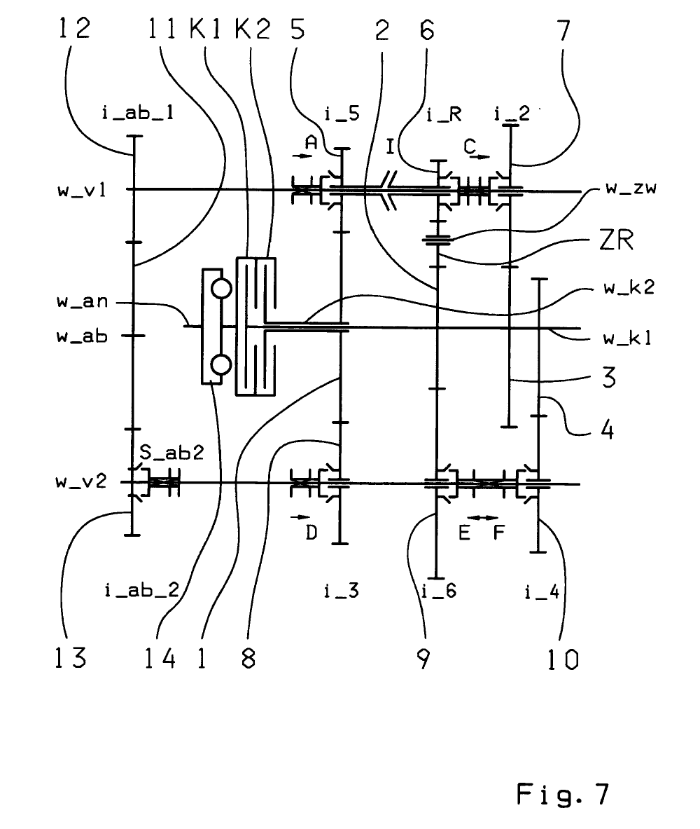

In the second and third embodiment, in accordance with FIGS. 3 and 5, in the first gear plane, designed as dual gear plane 5-8, the fixed gear wheel 1 on the second transmission input shaft w_K2 meshes with the idler gear wheel 5 on the first countershaft w_v1, and with the idler gear wheel 8 on the second countershaft w_v2. In the second gear plane, designed as dual gear plane 6-9, the gear 2, on the first transmission input shaft w_K1, meshes with the idler gear wheel 6 on the first countershaft w_v1, and with the idler gear wheel 9 on the second countershaft w_v2. In the third gear plane, designed as single gear plane 7-3, the fixed gear wheel 3 on the first transmission input shaft w_K1 meshes with the intermediate gear ZR, whereby the intermediate gear ZR enables the reversal of rotation for the realization of reverse gears R1, R2. The intermediate gear ZR is rotatably positioned on an intermediate shaft w_zw, whereby the intermediate shaft_zw is positioned parallel to the countershafts w_v1, w_v2. The intermediate gear ZR also meshes with the idler gear wheel 7 on the first countershaft w_v1. Finally, in the fourth gear plane, designed as single gear plane 4-10, the fixed gear wheel 4 on the first transmission input shaft w_K1 meshes with the idler gear wheel 10 on the second countershaft w_v2. The fourth embodiment, in accordance with FIG. 7, only differs by the fact, that the intermediate gear for the reversal of rotation is implemented in the second gear plane, designed as dual gear plane 6-9, for the fixed gear wheel 2 and the idler gear wheel 6.

In the first and fifth embodiments, in accordance with FIGS. 1 and 9, dual side operating coupling devices B, C; E, F are positioned on each countershaft w_v1, w_v2, whereby, on the first countershaft w_v1, the dual action coupling device B, C is positioned between the second gear plane, designed as single gear plane 6-2, and the fourth gear plane, designed as dual gear plane 7-10, and the dual action coupling device E, F is positioned on the second countershaft w_v2, between the third gear plane, designed as single gear plane 3-9 and the fourth gear plane, designed as dual gear plane 7-10.

In the second and third embodiments, in accordance with FIGS. 3 and 5, a dual action coupling device B, C; E, F is also positioned on each countershaft w_v1, w_v2, whereby the dual action coupling device B, C on the first countershaft w_v1 is positioned between the second gear plane, designed as dual gear plane 6-9, and the third gear plane, designed as single gear plane 7-3, and the dual action coupling device E, F on the second countershaft w_v2 is positioned between the second gear plane, designed as dual gear plane 6-9 and the fourth gear plane, designed as single gear plane 4-10. The fourth embodiment, in accordance with FIG. 7, differs only by the fact, that on the first countershaft w_v1, instead of the dual action coupling device B, C, a single side operating coupling device C is provided which is assigned to the idler gear wheel 7 on the first countershaft w_v1.

Independent of the respective embodiment, for each dual action coupling device B, C; E, F two single side operating coupling devices can be provided. The idler gear wheel 6 can be connected through the coupling device B with the first countershaft w_v1, and the idler gear wheel 7 can be connected through the coupling device C with the first countershaft w_v1. The idler gear wheel 9 can be connected through the coupling device E with the second countershaft w_v2, and the idler gear wheel 10 can be connected by way of the coupling device F with the second countershaft w_v2.

Furthermore, each embodiment provides that a single side operating coupling device A is assigned to the first gear plane as a dual gear plane 5-8, to enable connection of the idler gear wheel 5 with the first countershaft w_v1. Also, a single side operating coupling device D is assigned to the first gear plane as a dual gear plane 5-8, to connect the idler gear wheel 8 with the second countershaft w_v2.

In the inventive dual clutch transmission, an integrated output step is provided through the output gear wheel 12 and the output gear wheel 13, whereby the output gear wheel 12 and the output gear wheel 13 each mesh with a fixed gear wheel 11 on the output shaft w_ab. In all embodiments, the output gear wheel 13 is shiftably coupled, via the coupling device S_ab2, with the second countershaft w_v2, whereby the output gear wheel 12 can be connected with the second countershaft w_v2 in a rotationally fixed manner.

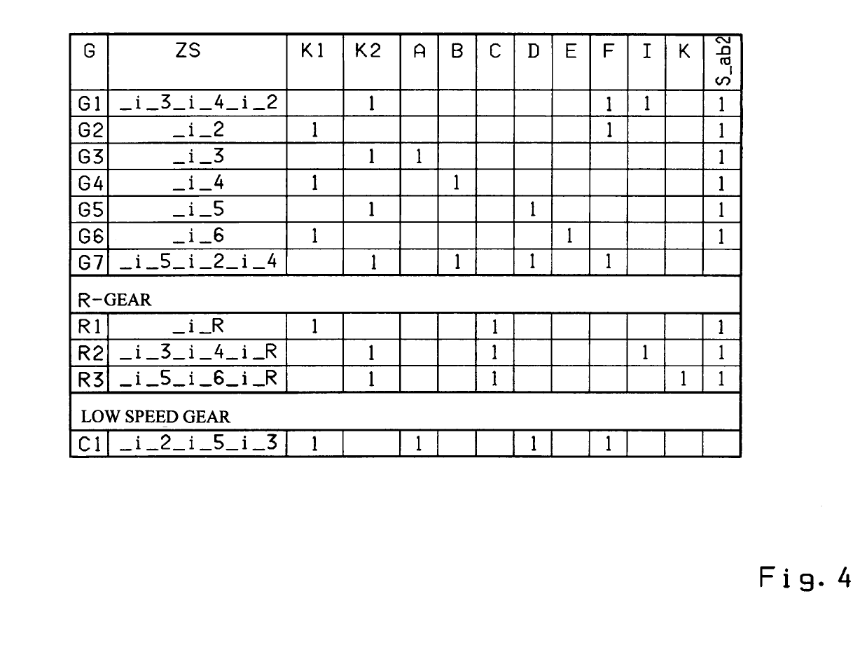

In the presented tables in FIGS. 2 and 4, exemplary shifting schemes for the first and second embodiment of the 7-gear dual clutch transmission are shown, in accordance with FIGS. 1 and 3.

As seen from the shifting schemes the first forward gear G1 can be shifted via the second clutch K2, via the activated coupling device F, and when the coupling device S_ab2 is engaged, also via the engaged shifting device I as a winding-path gear, the second forward gear G2 can be shifted via the first clutch K1 and via the activated coupling device F, and when the coupling device S_ab2 is engaged, the third forward gear G3 can be shifted via the second clutch K2 and via the activated coupling device A, and when the coupling device S_ab2 is engaged, the fourth forward gear G4 can be shifted via the first clutch K1 and via the activated coupling device B, when the coupling device S_ab2 is engaged, the fifth forward gear G5 can be shifted via the second clutch K2 and via the activated coupling device D and when the coupling device S_ab2 is engaged, the sixth forward gear G6 can be shifted via the first clutch K1 and via the activated coupling device E and when the coupling device S_ab2 is engaged, the seventh forward gear G7 can be shifted via the second clutch K2, via the activated coupling device B, via the activated coupling device D, and via the activated coupling device F, and as a winding-path gear when the coupling device S_ab2 is engaged. Also, a reverse gear R1 can be shifted via the first clutch K1 and via the activated coupling device C, and when the coupling device S_ab2 is engaged, and a second reverse gear R2 can be shifted via the second clutch K2 and via the activated coupling device C, and via the activated or engaged shifting device I as a winding-path gear, and a low speed gear C1 can be shifted via the first clutch K1, via the activated coupling device A, via the activated coupling device D, and via the activated coupling device F, as a winding-path gear when the coupling device S_ab2 is not engaged.

In the first and second embodiment, if an additional shifting device K is positioned, for instance, on the second countershaft w_v2, an additional reverse gear R3 can be shifted via the second clutch K2 and via the activated coupling device C as a winding-path gear, if the additional shifting device K and the coupling device S_ab2 are engaged.

From the shifting schemes, in accordance with FIGS. 2 and 4, it can be seen that in the first forward gear G1, starting from the clutch K2, the gear wheel steps i_3, i_4, and i_2 are used in addition to the of coupling the two partial transmissions by way of the engaged shifting device I. In the second forward gear G2, only the gear wheel step i_2 is used, in the a third forward gear G3, the gear wheel step i_3, in the fourth forward gear G4, the gear wheel step i_4, in the fifth forward gear G5, the gear wheel step i_5, and in the sixth forward gear G6, the gear wheel step i_6 is used. In the seventh forward gear G7, the gear wheel steps i_5, i_2, and i_4 are used in addition to the coupling the two partial transmissions by way of the non-engaged coupling device S_ab2. In the reverse gear R1, only the gear wheel step i_R is used in the fourth gear plane, which is designed as dual gear plane 7-10, or in the third gear plane, designed as single gear plane 7-3 whereby the additional, possible reverse gear R2, is shifted as a winding-path gear, starting from the second clutch K2, and using the gear wheel steps i_3, i_4, and i_R, whereby the possibility of coupling the two partial transmissions by way of the engaged shifting device I and the coupling device S_ab2, which is assigned to the output gear wheel 13 on the second countershaft w_v2. Also in the additional reverse gear R3, shifted as a winding-path gear, the gear wheel steps i_5, i_6, and i_R are used, whereby the possibility of coupling the two partial transmissions by way of the engaged shifting device K and the coupling device S_ab2. Finally, in the low speed gear C1, starting from the first clutch K1, the gear wheel steps i_2, i_5, and i_3 are used, whereby the possibility of coupling the two partial transmissions by way of the disengaged coupling device S_ab2.

Due to the fact, that in the first embodiment the gear wheel steps of the fourth forward gear G4 and the sixth forward gear G6 are each assigned to a single gear plane 6-2, 3-9, and therefore can be freely adapted, the transmission shifting of the upper forward gears G4 to G7 can be well adjusted. Due to the fact, that in the a second embodiment the gear wheel step of the second forward gear G2 is assigned to a single gear plane 4-10, and that the first forward gear G1 is winding via the gear wheel step of the second forward gear G2, the gear stepping in the lower forward gears G1 to G3 can be better matched than in the first embodiment.

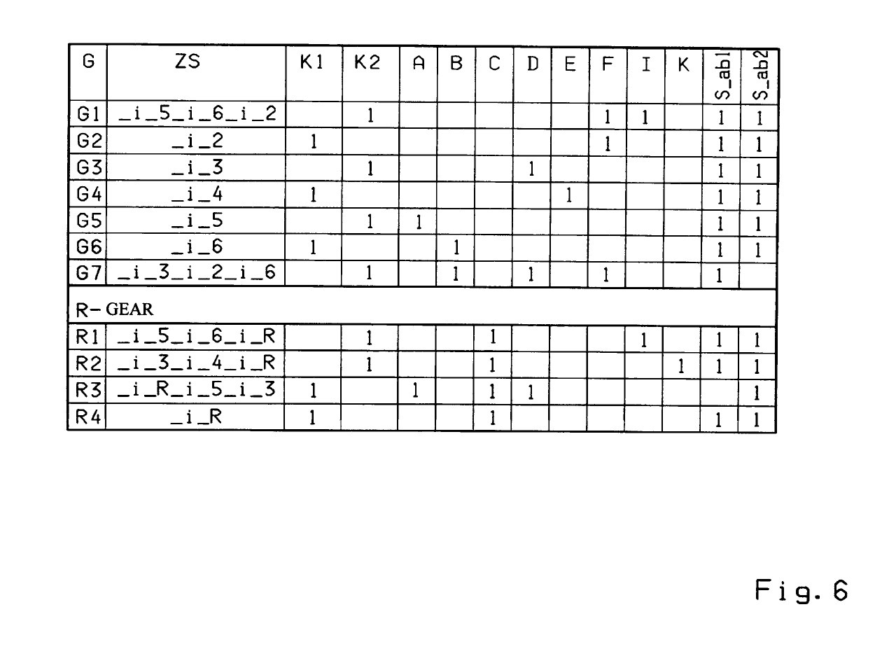

The presented table, in accordance with FIG. 6, shows an exemplary shifting scheme for the third embodiment of the 7-gear dual clutch transmission, in accordance with FIG. 5.

From the shifting scheme can be seen, that the first forward gear G1 is shifted via the second clutch K2, via the activated coupling device F, and, when the coupling device S_ab2 is engaged, via the activated or engaged shifting device I as a winding-path gear, the second forward gear G2 can be shifted via the first clutch K1 and via the activated coupling device F, when the coupling device S_ab2 is engaged, the third forward gear G3 can be shifted via the second clutch K2 and via the activated coupling device D, when the coupling device S_ab2 is engaged, the fourth forward gear G4 can be shifted via the clutch K1 and via the activated coupling device E, when the coupling device S_ab2 is engaged, the fifth forward gear G5 can be shifted via the second clutch K2 and via the activated coupling device A, when the coupling device S_ab2 is engaged, the sixth forward gear G6 can be shifted via the first clutch K1 and via the activated coupling device B, when the coupling device S_ab2 is engaged, and the seventh forward gear G7 can be shifted via the second clutch K2, via the activated coupling device B, via the activated coupling device D, and via the activated coupling device F as a winding-path gear, when the coupling device S_ab2 is disengaged. Also, a reverse gear R1 can be shifted via the second clutch K2, via the activated coupling device C, when the coupling device S_ab2 is engaged, and via the activated shifting device I as a winding-path gear, and an additional reverse gear R4 can be shifted via the first clutch K1 and via the activated coupling device C, when the coupling device S_ab2 is engaged. Furthermore, an additional reverse gear R2 can be shifted via the second clutch K2 and via the activated or engaged coupling device C as a winding-path gear, if an additional shifting device K and the coupling device S_ab2 are engaged. An additional reverse gear R3 can be shifted via the first clutch K1, via the activated coupling device A, via the activated coupling device C, via the activated coupling device D and as a winding gear, when the coupling device S_ab2 is engaged, and an additional coupling device S_ab1 is disengaged.

From the shifting scheme, in accordance with FIG. 6, it can be seen that in the first forward gear G1, starting from the a second clutch K2, the gear wheel steps i_5, i_6, and i_2 are used, and coupling the two partial transmissions is realized by way of the engaged shifting device I. In the second forward gear G2, only the gear wheel step i_2 is used, in the third forward gear G3, the gear wheel step i_3, in the fourth forward gear G4, the gear wheel step i_4, in the fifth forward gear G5, the gear wheel step i_5, and in the sixth forward gear G6, the gear wheel step i_6 is used. In the seventh forward gear G7, the gear wheel steps i_3, i_2, and i_6 are used and coupling of the two partial transmissions is realized by way of the disengaged coupling device S_ab2. In the reverse gear R1, shifted as a winding-path gear, only the gear wheel steps i_5, i_6, and i_R are used, and the two partial transmissions are coupled via the engaged shifting device and when the coupling device S_ab2 is engaged. The additional, possible reverse gear R2, shifted as a winding-path gear starting from the second clutch K2, the gear wheel steps i_3, i_4, and i_R and coupling the two partial transmissions is realized via the engaged shifting device K and the engaged coupling device S_ab2, which is assigned to the output gear wheel 13 on the second countershaft w_v2. Also, in a next reverse gear R3 shifted as a winding-path gear, the gear wheel steps i_R, i_5, and i_3 are used and coupling of the two partial transmissions is realized when the coupling device S_ab1 is disengaged and the coupling device S_ab2 is engaged.

The third embodiment realizes a power shiftable 7-gear transmission and due to the fact that the gear wheel steps of the second forward gear G2 are positioned on a countershaft with the gear wheel steps of the forward gears G3 and G4, advantages arise in the gearing configuration and in regard to the bearing of the shafts and the shaft configuration.

From the shifting scheme it is seen, that the first forward gear G1 can be shifted via the second clutch K2, via the activated coupling device C, via the activated coupling device D, and via the activated coupling device F, and when the coupling device S_ab2 is disengaged as a winding-path gear, the second forward gear G2 can be shifted via the first clutch K1 and via the activated coupling device C, when the coupling device S_ab2 is engaged, the third forward gear G3 can be shifted via the second clutch K2 and via the activated coupling device D, when the coupling device S_ab2 is engaged, the fourth forward gear G4 can be shifted via the first clutch K1 and via the activated coupling device F, when the coupling device S_ab2 is engaged, the fifth forward gear G5 can be shifted via the second clutch K2 and via the activated coupling device A, when the coupling device S_ab2 is engaged, the sixth forward gear G6 can be shifted via the first clutch K1, and via the activated coupling device E, when the coupling device S_ab2 is engaged, and the seventh forward gear G7 can be shifted via the first clutch K1, via the activated coupling device A, via the activated coupling device D, and via the activated coupling device F, and when the coupling device S_ab2 is not engaged as a winding-path gear. Also, a reverse gear R1 can be shifted via the second clutch K2 and via the activated coupling device C, and via the activated coupling device I, and when the coupling device S_ab2 is engaged as a winding-path gear,

In the fourth embodiment, if an additional coupling device S_ab1 is provided on the first countershaft w_v1, assigned to the output gear wheel 12, to decouple it from the first countershaft w_v1 when the coupling device S_ab1 is non-engaged, a low speed gear C1 can be shifted via a first clutch K1, via the engaged coupling device A, via the engaged coupling device C, and via the engaged coupling device D, and when the coupling device S_ab2 is engaged as a winding-path gear, if the additional coupling device S_ab1 is disengaged. Also, an overdrive gear O1 can be shifted via the second clutch K2, via the engaged or activated coupling device A, via the engaged coupling device C, and via the activated coupling device F, and when the coupling device S_ab2 is engaged as a winding-path gear, if the additional coupling device S_ab1 is disengaged.

In the fourth embodiment, if an additional shifting device is positioned on the second countershaft w_v2, to connect the idler gear wheel 8 with the idler gear wheel 9 on the second countershaft w_v2, when the shifting device K for the coupling of the two partial transmissions is engaged, an additional overdrive gear O2 can be shifted via the first clutch K1 and via the engaged coupling device A, and when the coupling device S_ab2 is engaged as a winding-path gear, if the additional shifting device K is engaged.

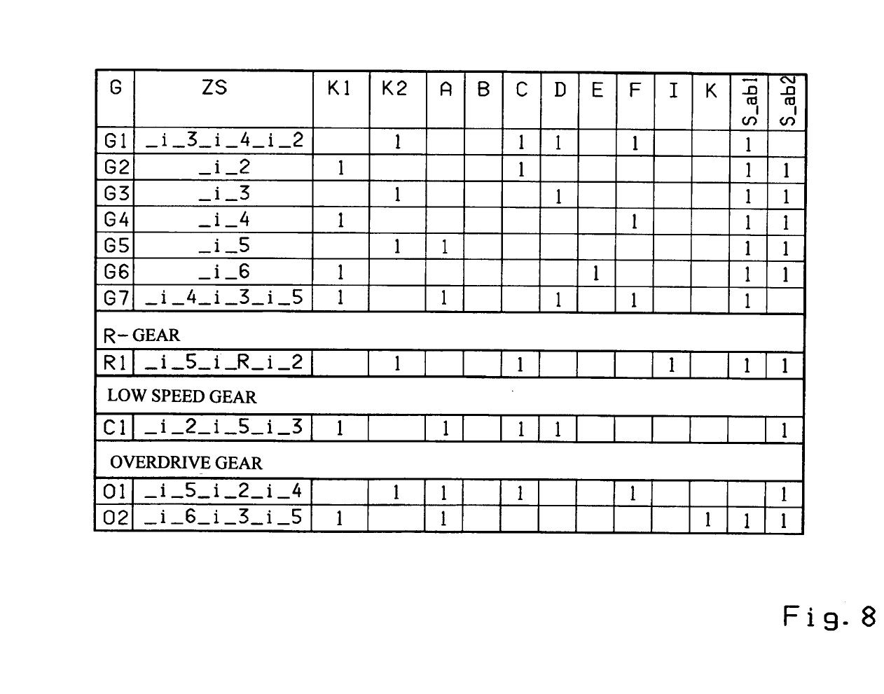

From the shifting scheme, in accordance with FIG. 8, it can be seen that, in the first forward gear O1, starting from the second clutch K2, the gear wheel steps i_3, i_4, and i_2 are used, whereby the possibility for the coupling of the two partial transmissions is realized when the coupling device S_ab2 is disengaged. In the second forward gear G2, only the gear wheel step i_2 is used, in the third forward gear G3, the gear wheel step i_3, and the fourth forward gear G4, the gear wheel step i_4, in the fifth forward gear G5, the gear wheel steps i_5, in the sixth forward gear G6, the gear wheel steps i_6 are used. In the seventh forward gear G7, shifted as winding-path gear, the gear wheel steps i_4, i_3, and i_5 are applied, and for the coupling of the two partial transmissions is realized by way of the disengaged coupling device S_ab2. In the reverse gear R1, shifted as a winding-path gear, only the gear wheel steps i_5, i_R, and i_2 are used and the two partial transmissions are coupled via the engaged shifting device I and an engaged coupling device S_ab2. In the low speed gear C1, shifted as a winding gear, the gear wheel steps i_2, i_5, and i_3 are used and of coupling the two partial transmissions is realized via the disengaged coupling device S_ab1. Also, in the overdrive gear O1, shifted as a winding-path gear, the gear wheel steps i_5, i_2, and i_4 are used and the coupling of the two partial transmissions is realized by way of the disengaged coupling device S_ab1. Finally, the additional overdrive gear O2 is realized by way of the use of the gear wheel steps i_6, i_3, and i_5 shifted as a winding gear, through the use of the engaged shifting device K and an engaged coupling device S_ab2.

Due to the fact that, in the a fourth embodiment, the gear wheel steps of the second forward gear G2 and of the fourth forward gear are each assigned to a single gear plane 7-3, 4-10, and that the first forward gear is winding via the gear wheel steps i_2 and i_4, and the seventh forward gear G7 is winding via the gear wheel steps i_4, the transmission ratio shifting can be well adjusted. Also, just three shifting locations are needed on the first countershaft w_v1.

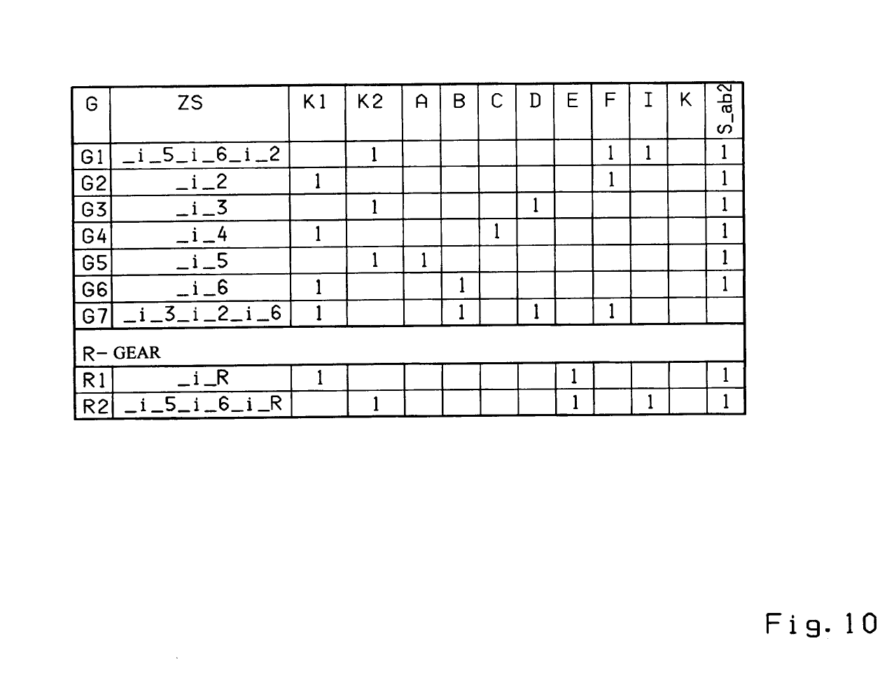

The table, as presented in FIG. 10, shows an exemplary shifting scheme for the fifth embodiment of the 7-gear dual clutch transmission, in accordance with FIG. 9.

From the shifting scheme, it can be seen, that the first forward gear G1 can be shifted via the second clutch K2 and via the activated coupling device F, and via the activated shifting device I, and when the coupling device S_ab2 is engaged as a winding-path gear, the second forward gear G2 can be shifted via the first clutch K1 and via the activated coupling device F and when the coupling device S_ab2 is engaged, the third forward gear G3 can be shifted via the second clutch K2 and via the activated coupling device D and when the coupling device S_ab2 is engaged, the fourth forward gear G4 can be shifted via the first clutch K1 and via the activated coupling device C and when the coupling device S_ab2 is engaged, the fifth forward gear G5 can be shifted via the second clutch K2 and via the activated coupling device A and when the coupling device S_ab2 is engaged, the sixth forward gear G6 can be shifted via the first clutch K1 and via the activated coupling device B, and when the coupling device S_ab2 is engaged, and the seventh forward gear G7 can be shifted via the first clutch K1, via the activated coupling device B, via the activated coupling device D, and via the activated coupling device F, and when the coupling device S_ab2 is not engaged as a winding-path gear. In addition, a reverse gear R1 can be shifted via the first clutch K1 and via the activated coupling device E, when the coupling device S_ab2 is engaged, and an additional reverse gear R2 can be shifted via a second clutch K2 and via the activated coupling device E, and as via the activated or engaged shifting device I as a winding gear.

From the shifting scheme, in accordance with FIG. 10, it can be seen that in the first forward gear G1, designed as winding-path gear, starting from the second clutch K2, the gear wheel steps i_5, i_6, and i_2 are used, whereby the two partial transmissions are coupled via the engaged shifting device I. In the second forward gear G2, only the gear wheel step i_2 is used, in the third forward gear G3, the gear wheel step i_3, in the fourth forward gear G4, the gear wheel step i_4, in the fifth forward gear G5, the gear wheel step i_5, and in the sixth forward gear G. 6, the gear wheel step i_6 is used. In the seventh forward gear G7, shifting as a winding-path gear, the gear wheel steps i_3, i_2, and i_6 are used, and coupling of the two partial transmissions is realized by way of the engaged coupling device S_ab2. In the reverse gear R1, only the gear wheel step i_R is used, and an additional reverse gear R2, shifted as a winding-path gear, uses the gear wheel steps i_5, i_6, and i_R, and coupling the two partial transmissions is realized via the engaged shifting device I.

In the fifth embodiment, a power shiftable 7-gear transmission is realized by the fact, that the gear wheel step of the sixth forward gear G6 is assigned to a single gear plane 6-2, the first forward gear G1 is winding via the gear wheel steps i_5, i_6, and i_2, and the seventh forward gear G7 is winding via the gear wheel steps i_3, i_2, and i_6, so that geometric transmission shifting can be well adjusted.

Summarizing the first embodiment, in accordance with FIGS. 1 and 2, it can be seen, in the first gear plane, designed as dual gear plane 5-8, that the idler gear wheel 5 can be used for three forward gears G1, G3, C1, as well as for a reverse gear R2, and the idler gear wheel 8 can be used for three forward gears G5, G7, C1, as well as for a reverse gear R3. In the second gear plane, designed as single gear plane 6-2, the idler gear wheel 6 can be used for three forward gears G1, G4, G7, and for a reverse gear R4. Also, in the third gear plane, designed as single gear plane 3-9, the idler gear wheel 9 can be used for a forward gear G6 and for a reverse gear R3. Finally in the fourth gear plane, designed as dual gear plane 7-10, the idler gear wheel 7 can only be used for the reverse gears R1, R2, R3, and the idler gear wheel can be used for four forward gears G1, G2, G7, C1.

The second embodiment, in accordance with FIGS. 3 and 4 differs from the first embodiment in regard to the use of the different idler gear wheels by the fact, that the second gear plane is a dual gear plane 6-9, and the fourth gear plane is a single gear plane 4-10.

The third embodiment, in accordance with FIGS. 5 and 6, can be summarized, that in the first gear plane, designed as dual gear plane 5-8, the idler gear wheel 5 is used for two forward gears G1, G5, as well as for two reverse gears R1, R3, and that the idler gear wheel 8 is used for two forward gears G3, G7, as well as for two reverse gears R2, R3. In the second gear plane, designed as dual gear plane 6-9, the idler gear wheel 6 can be used for three forward gears G1, G6, G7, as well as for a reverse gear R1, and the idler gear wheel 9 can be used for a forward gear G4, as well as for a reverse gear R2. Also, in the third gear plane, designed as single gear plane 7-3, the idler gear wheel 7 can be used for four reverse gears R1, R2, R3, R4. Finally, in the fourth gear plane, designed as single gear plane 4-10, the idler gear wheel can be used for three forward gears G1, G2, G7.

Summarizing the fourth embodiment, in accordance with FIGS. 7 and 8, it can be seen that in the first gear plane, designed as dual gear plane 5-8, the idler gear wheel 5 can be used for five forward gears G5, G7, C1, O1, O2, as well as for a reverse gear R1, and the idler gear wheel 8 can be used for five forward gears G1, G3, G7, C1, O2. In the second gear plane, designed as dual gear plane 6-9, the idler gear wheel 6 can be used for a reverse gear R1 and the idler gear wheel 9 can be used for a forward gear G6, O2. In addition, in the a third gear plane, designed as single gear plane 7-3, the idler gear wheel 7 can be used for four forward gears G1, G2, C1, O1, as well as for a reverse gear R1. Finally, in the fourth gear plane, designed as single gear plane 4-10, the idler gear wheel 10 can be used for four forward gears G1, G4, G7, O1.

Summarizing the fifth embodiment, in accordance with FIGS. 9 and 10, it can be seen that in the first gear plane, designed as dual gear plane 5-8, the idler gear wheel 5 can be used for two forward gears G1, G5, as well as for a reverse gear R2, and the idler gear wheel 8 can be used for two forward gears G3, G7. In the second gear plane, designed as a single gear plane 6-2, the idler gear wheel 6 can be used for three forward gears G1, G6, G7, as well as for a reverse gear R2. Also, in the third gear plane, designed as single gear plane 3-9, the idler gear wheel 9 can be used for two reverse gears R1, R2. Finally, in the fourth gear plane, designed as dual gear plane 7-10, the idler gear wheel 7 can be used for a forward gear G4, and the idler gear wheel 10 can be used for three forward gears G1, G2, G7.

In all embodiments of the dual clutch transmission and due to the multiple use of certain idler gear wheels, less gear planes are required and therefore less components, but still having the same amount of gears, resulting in an advantageous construction space saving and in a cost reduction.

Independent from the respective embodiment, the numeral “1” in a box of the tables of the shift schemes means that the associated clutch K1, K2, or the associated coupling devices A, B, C, D, E, F or the associated shifting devices K, I are engaged. In contrast, an empty box in the respective table of the shift schemes means that the associated clutch K1, K2, or the associated coupling device A, B, C, D, E, F or the associated shifting device K, I are each disengaged.

Deviating from the previously mentioned rules, it applies for the coupling device S_ab1, or S_ab2 assigned to an output gear wheel 12 or output gear wheel 13, respectively, that the coupling device S_ab1, or S_ab2, respectively, in case of an empty box in the associated table of the shift schemes, must be non-engaged but that, a box having the numeral “1”, depending on the gear in a first group of gears, the coupling device S_ab1, or S_ab2, respectively, must be engaged, and in a second group of gears, the coupling device S_ab1, or S_ab2, respectively, can be both disengaged or engaged. In addition, there is the possibility in many cases to add additional coupling devices or shifting devices, without affecting the flow of force. Pre-selection of a gear is hereby enabled.

### REFERENCE CHARACTERS

1 Fixed Wheel on the second transmission input shaft
2 Fixed Wheel on the first transmission input shaft
3 Fixed Wheel on the first transmission input shaft
5 Idler gear wheel on the first countershaft
6 Idler gear wheel on the first countershaft
7 Idler gear wheel on the first countershaft
8 Idler gear wheel on the second countershaft
9 Idler gear wheel on the second countershaft
10 Idler gear wheel on the second countershaft
K1 first clutch
K2 second clutch
w_an Drive Shaft
w_ab Output Shaft
w_v1 first Countershaft
w_v2 second Countershaft
A Coupling Device
B Coupling Device
C Coupling Device
D Coupling Device
E Coupling Device
F Coupling Device
i_1 Gear Wheel Step, first forward gear
i_2 Gear Wheel Step, second forward gear
i_3 Gear Wheel Step, third forward gear
i_4 Gear Wheel Step, fourth forward gear
i_5 Gear Wheel Step, fifth forward gear
i_6 Gear Wheel Step, sixth forward gear
G1 First forward gear
G2 Second forward gear
G3 Third forward gear
G4 Fourth forward gear
G5 Fifth forward gear
G6 Sixth forward gear
G7 Seventh forward gear
C1 Low Speed Gear
O1 Overdrive Gear
R1 Reverse Gear
R2 Reverse Gear
R3 Reverse Gear
w_zw Intermediate Shaft
ZR Intermediate Gear
11 Fixed gear wheel of the Drive Shaft
12 Output Gear Wheel of the first Countershaft
13 Output Gear Wheel of the second Countershaft
14 Torsion Vibration Damper
ZS Gear Wheel Step in use
S_ab1 Coupling Device, optional
S_ab2 Coupling Device, optional
K Shifting device
I Shifting device

1-14. (canceled)

15. A dual clutch transmission comprising:
first and second clutches (K1, K2) each having an input side connected to a drive input shaft (w_an) and an output side respectively connected to one of first and second transmission input shafts (w_K1, w_K2) arranged coaxially with one another;
at least first and second countershafts (w_v1, w_v2) rotatably supporting a plurality of idler gear wheels (5, 6, 7, 8, 9, 10);
at least one fixed gear wheel (1, 2, 3, 4) being connected in a fixed manner on each of the first and the second transmission input shafts (w_K1, w_K2), and each fixed gear wheel (1, 2, 3, 4) engaging at least some of the idler gear wheels (5, 6, 7, 8, 9, 10);
a plurality of coupling devices (A, B, C, D, E, F) being supported on the first and the second countershafts (w_v1, w_v2), each of the coupling devices (A, B, C, D, E, F) coupling an idler gear wheel (5, 6, 7, 8, 9, 10) in a rotationally fixed manner to one of the first and the second countershafts (w_v1, w_v2);
output gear wheels (12, 13) each engaging gearing of an output shaft (w_ab) such that several power shiftable forward gears (1, 2, 3, 4, 5, 6) and at least one reverse gear (R1, R2, R3) are shiftable;
first and second dual gear wheel planes (5-8, 7-10; 5-8, 6-9) each comprising an idler gear wheel (5, 6, 7, 8, 9, 10) supported on the first countershaft (w_v1), an idler gear wheel (5, 6, 7, 8, 9, 10) supported on the second countershaft (w_v2), and a fixed gear wheel (1, 2, 3, 4) supported on one of the first and the second transmission input shafts (w_K1, w_K2), at least one idler gear wheel (5, 6, 7, 8, 9, 10) in each of the first and the second dual gear wheel plane (5-8, 7-10; 5-8, 6-9) being used for implementing at least two gears; and
first and second single gear wheel planes (6-2, 3-9; 7-3, 4-10) each comprising an idler gear wheel (5, 6, 7, 8, 9, 10) supported on one of the first and the second countershafts (w_v1, w_v2) and a fixed gearwheel (1, 2, 3, 4) supported on one of the first and the second transmission input shafts (w_K1, w_K2), at least one winding-path gear is engaged by at least a shifting device (I) on the first countershaft (w_v1), and at least one winding-path gear is engaged by a disengaged output coupling device (S_ab2) assigned to an output gear wheel (13) on the second countershaft (w_v2).

16. The double clutch transmission according to claim 15, wherein an idler gearwheel (5) of a second partial transmission is connected, via the shifting device (I) on the first countershaft (w_v1), to an idler gear wheel (6) of a first partial transmission such that at least one of a first forward gear (G1) and a reverse gear (R1, R2) is shifted as a winding-path gear by engagement of the shifting device (I), and at least a seventh forward gear (G7) is shifted as a winding-path gear by disengaging the output coupling device (S_ab2) on the second countershaft (w_v2) to decoupled the output gear wheel (13) from the second countershaft (w_v2).

17. The double clutch transmission according to claim 16, wherein a low speed gear (C1) is engaged as a winding-path gear by disengagement of the output coupling device (S_ab2) on the second countershaft (w_v2).

18. The double clutch transmission according to claim 16, wherein a first forward gear (G1) is engaged as a winding-path gear by disengagement of the output coupling device (S_ab2) on the second countershaft (w_v2).

19. The double clutch transmission according to claim 15, wherein the first gear dual gear wheel plane (5-8) and comprises a fixed gear wheel (1) on the second transmission input shaft (w_K2) of a second partial transmission, and the second and the third gearwheel planes (6-2, 3-9) are single gear wheel planes, and the fourth gear plane is a dual gear wheel plane (7-10) and the second, the third and the third gear wheel planes (6-2, 3-9, 7-10) each comprise a fixed gear wheel (2, 3, 4) on the first transmission input shaft (w_K1) of a first partial transmission.

20. The double clutch transmission according to claim 15, wherein the first gear plane is a dual gear wheel plane (5-8) and comprises a fixed gear wheel (1) on the second transmission input shaft (w_K2) of a second partial transmission, the second gear plane is a dual gear wheel plane (6-9), and the third and the fourth gear planes (7-3, 4-10) are single gear wheel planes, and the second, the third and the third gearwheel planes (6-2, 3-9, 7-10) each comprise a fixed gear wheel (2, 3, 4) on the first transmission input shaft (w_K1) of a first partial transmission.

21. The double clutch transmission according to claim 15, wherein
a first forward gear (G1) is engaged as a winding-path gear by engagement of the second clutch (K2), a fifth coupling device (F) and the shifting device (I);
a second forward gear (G2) is engaged by engagement of the first clutch (K1) and the fifth coupling device (F);
a third forward gear (G3) is engaged by engagement of the second clutch (K2) and a first coupling device (A);
a fourth forward gear (G4) is engaged by engagement of the first clutch (K1) and a second coupling device (B);
a fifth forward gear (G5) is engaged by engagement of the second clutch (K2) and a third coupling device (D);
a sixth forward gear (G6) is engaged by engagement of the first clutch (K1) and a fourth coupling device (E); and
a seventh forward gear (G7) is engaged as a winding-path gear by engagement of the second clutch (K2), the second coupling device (B), the third coupling device (D) and the fifth coupling device (F) and disengagement of the output coupling device (S_ab2) on the second countershaft (w_v2).

22. The double clutch transmission according to claim 21, wherein a first reverse gear (R1) is engaged by engagement of the first clutch (K1) and a sixth coupling device (C), an additional reverse gear (R2) is engaged as a winding-path gear by engagement of the second clutch (K2), the sixth coupling device (C) and the shifting device (I), and the low-speed gear (C1) is engaged as a winding-path gear by engagement of the first clutch (K1), the first coupling device (A), the third coupling device (D), and the fifth coupling device (F), and disengagement of the output coupling device (S_ab2) on the second countershaft (w_v2).

23. The double clutch transmission according to claim 15, wherein
a first forward gear (G1) is engaged as a winding-path gear by engagement the second clutch (K2), a fifth coupling device (F) and the shifting device (I);
a second forward gear (G2) is engaged by engagement of the first clutch (K1) and the fifth coupling device (F);
a third forward gear (G3) is engaged by engagement of the second clutch (K2) and a third coupling device (D);
a fourth forward gear (G4) is engaged by engagement of the first clutch (K1) and a fourth coupling device (E);
a fifth forward gear (G5) is engaged by engagement of the second clutch (K2) and a first coupling device (A);
a sixth forward gear (G6) is engaged by engagement of the first clutch (K1) and a second coupling device (B); and
a seventh forward gear (G7) is engaged as a winding-path gear by engagement of the second clutch (K2), the second coupling device (B), the third coupling device (D) and the fifth coupling device (F), and disengagement of the output coupling device (S_ab2) on the second countershaft (w_v2).

24. The double clutch transmission according to claim 23, wherein a first reverse gear (R1) is engaged as a winding-path gear by engagement of the second clutch (K2), a sixth coupling device (C) and the shifting device (I), and an additional reverse gear (R4) is engaged by engagement of the first clutch (K1) and the sixth coupling device (C).

25. The double clutch transmission according to claim 15, wherein
a first forward gear (G1) is engaged as a winding-path gear by engagement of the second clutch (K2), a second coupling device (C), a third coupling device (D), and a fifth coupling device (F), and disengagement of the output coupling device (S_ab2) on the second countershaft (w_v2);
a second forward gear (G2) is engaged by engagement of the first clutch (K1) and the second coupling device (C);
a third forward gear (G3) is engaged by engagement of the second clutch (K2) and the third coupling device (D);
a fourth forward gear (G4) is engaged by engagement of the first clutch (K1) and the fifth coupling device (F);
a fifth forward gear (G5) is engaged by engagement of the second clutch (K2) and a first coupling device (A);
a sixth forward gear (G6) is engaged by engagement of the first clutch (K1) and a fourth coupling device (E); and
a seventh forward gear (G7) is engaged as a winding-path gear by engagement of the first clutch (K1), the first coupling device (A), the third coupling device (D) and the fifth coupling device (F) and disengagement of the output coupling device (S_ab2) on the second countershaft (w_v2).

26. The double clutch transmission according to claim 25, wherein a reverse gear (R1) is engaged as a winding-path gear by engagement of the second clutch (K2), the third coupling device (C), and the shifting device (I).

27. The double clutch transmission according to claim 15, wherein
a first forward gear (G1) is engaged as a winding-path gear by engagement of the second clutch (K2), a fifth coupling device (F), and the shifting device (I);
a second forward gear (G2) is engaged by engagement of the first clutch (K1) and the fifth coupling device (F);
a third forward gear (G3) is engaged by engagement of the second clutch (K2) and a fourth coupling device (D);
a fourth forward gear (G4) is engaged by engagement of the first clutch (K1) and a third coupling device (C);
a fifth forward gear (G5) is engaged by engagement of the second clutch (K2) and a first coupling device (A);
a sixth forward gear (G6) is engaged as a winding-path gear by engagement of the first clutch (K1), a second coupling device (B), a fourth coupling device (D) and the fifth coupling device (F), and disengagement of the output coupling device (S_ab2) on the second countershaft (w_v2).

28. The double clutch transmission according to claim 27, wherein a first reverse gear (R1) is engaged by engagement of the first clutch (K1) and a sixth coupling device (E) and an additional reverse gear (R2) is engaged as a winding-path gear by engagement of the second clutch (K2), the sixth coupling device (E) and the shifting device (I).
